(19) United States
(12) Patent Application Publication
(10) Pub. No.: US 2003/0014502 A1
(43) Pub. Date: Jan. 16, 2003

(54) E-service communication method and system

(76) Inventor: Gregory Stuart Snider, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 09/898,677

(22) Filed: Jul. 3, 2001

(51) Int. Cl. G06F 15/16

(52) U.S. Cl. 709/219; 709/203

(57) ABSTRACT

A method and system for network communication are provided which uses existing or new Agent Communication Language (ACL) with Structured Query Language (SQL) as the constraint language and extensible Markup Language (XML) for syntax. A communications network includes a server software module adapted to communicate with a machine user; an ACL interpreter adapted to communicate with the server software module; and a file system adapted to communicate with the ACL interpreter. The machine user sends requests to the server software module using an ACL with SQL as a constraint language.

### TECHNICAL FIELD

The present invention relates generally to network computers and software, and more particularly to a method and a system for E-service communication over existing Internet infrastructure.

### BACKGROUND ART

As known in the art, the Internet is a worldwide collection of networks and gateways that use the Transmission Control Protocol/Internet Protocol (TCP/IP) suite of protocols to communicate with one another. At the heart of the Internet is a backbone of high speed data communication lines between major nodes or host computers consisting of thousands of commercial, government, education, and other computer systems that route data and messages.

World Wide Web (“WWW” or “Web”) refers to the total set of interlinked hypertext documents residing on hypertext transfer protocol (HTTP) servers all around the world. Documents on the WWW, called pages or Web pages, have historically been written in hypertext mark-up language (HTML) identified by uniform resource locators (URL) that specify the particular machine and pathname by which a file can be accessed and transmitted from node to node to the end user under HTTP. A Web site is a related group of these documents and associated files, scripts, subprocedures, and databases that are served up by an HTTP server on the WWW.

Users need a browser program and an Internet connection to access a Web site. Browser programs, also called “Web browsers,” are client applications that enable a user to navigate the Internet and view HTML documents on the WWW, another network, or the user computer. Web browsers also allow users to follow codes called “tags” imbedded in an HTML document, which associate particular words and images in the document with URLs so that a user can access another file that may be half way around the world, at the press of a key or the click of a mouse.

These files may contain text (in a variety of fonts and styles), graphic images, movie files, and sounds as well as Java applets, Practical Extraction and Report Language (Perl) applications, other scripted languages, ActiveX-controls, or other small imbedded software programs that execute when the user activates them by, for example, clicking on a link. Scripts are applications that are executed by a HTTP server in response to a request by a client user. These scripts are invoked by the HTTP daemon to do a single job, and then they exit.

Electronic-commerce or E-services refers to business transactions by two or more entities over the Web. E-services have been growing very rapidly over the recent years. E-services offer indisputable benefits, including low transaction cost, short time-to-market, availability of services twenty-four hours a day and seven days a week, and the ability to reach a huge market, both domestic and international. It is expected that E-services will continue to grow significantly in the near future.

There are several paradigms that could serve as a foundation for E-service communication over the Web.

The first paradigm is the Document model, which uses HTML for representing and exchanging information. This model is developing further with extensible Markup Language (XML) [described at http://www.w3.org/XML] and related activities, such as Resource Description Framework (RDF) [described at http://www.w3.org/Metadata/RDF], XML Schema [described at http://www.w3.org/TR/xmlschema-1], and XML-QL [described at http://www.w3 .org/TR/1998/NOTE-xml-ql-19980819].

The second paradigm is the Object Oriented Programming (or “Object”) model which has been gaining popularity in the last decade, primarily as a methodology for application construction, as seen in languages such as C++ and Java, and infrastructures such as Common Object Request Broker Architecture (CORBA), Distributed Component Object Model (DCOM), Enterprise JavaBeans (EJB) and Jini. The Object model facilitates a natural model of a problem domain, modeling a problem or task in terms of objects and relationships between those objects. An object is an abstraction of a set of real world things such that all of the real world things in the set (termed “instances”) have the same characteristics; and all instances are subject to and conform to the same rules.

The third paradigm is the Collaborative Agent (Agent) model. The Agent model is described in Genesereth, “an Agent-Based Framework for Interoperability,” in “Software Agents,” Bradshaw (ed.), AAAI Press/the MIT Press, 1997. Though less well known, the Agent model is appealing because of its disciplined model of communication and robustness.

Although there are other paradigms, these three models are perhaps the leading candidates for E-services. The suitability of each of these paradigms for E-services can be assessed as follows:

The Document Model:

The foundation of the Document model on the Internet was HTML. This lightweight model allows a user to express and understand structured information in an easy way. The power of the model is its simplicity. For example, within a few hours, a user can create a Web page that can express not only information, but also simple actions (via hyperlinks). Without any more effort than pointing and clicking in a browser, a client can understand and interact with the Web page service immediately. In contrast, CORBA is more complicated to use in this respect.

HTML has several weaknesses as a foundation for E-services, though, many of which are being addressed by such organizations as the World Wide Web Consortium (W3C) [sited at http://www.w3.org] and CommerceNet [sited at http://www.commerce.net]:

Semantics. HTML documents are easily understandable by people, but not by machines—just the opposite of the problem with the Object model as will later be described. This problem is being addressed by XML, which is using tags to express semantic rather than graphic relationships within a document. XML does not support semantics directly, though: efforts such as RDF Schema, drawing from the knowledge representation community, are proposing stronger foundations for support of run-time semantics.

Constraints. Propositions and constraints are not easily expressible in HTML or even in XML. This is being addressed by several different efforts such as RDF Schema and XML Schema.

Actions. Expression of actions (such as requests or queries) in HTML is service-specific and limited, and requires a person in the loop to be carried out. Although XML and related efforts are moving towards a stronger semantic model, they are still very weak in the expression of actions.

Interaction Protocols. Many protocols for Web interaction are under development, such as Open Buying On the Internet (OBI) and Open Trading Protocol (OTP) but, as yet, there is still no general model for expressing or discovering arbitrary protocols at run-time.

Accordingly, even though the document model is evolving rapidly, it is not yet sufficient for E-services.

The Object Model:

Although the Object model has been a successful paradigm for the construction of applications, both distributed and localized, it is not a suitable model for E-services. There are several problems associated with the Object model:

Robustness. Objects are passive entities that rely on system designers and/or the runtime infrastructure for progress. For example, if object dependencies within an application are known at design time, a static partial ordering of classes or other strategy can be used to prevent deadlock in an application. On the other hand, if object dependencies are dynamic or otherwise unknown at design time, deadlock avoidance protocols can be implemented in the runtime system to guarantee forward progress. However, neither of the situations applies in the case of the communications over the Internet. Service/client relationships are inherently unknown at design time, and there is no runtime system spanning the Internet which can be trusted to supply the necessary runtime protocols. E-services (and E-clients) must be self-responsible for making progress in the hostile environment of the Internet.

Security. Objects “contain” both code and data. Downloading code for an object over the Internet presents a serious security risk.

Interaction Protocols. The Object model offers few mechanisms for expressing interaction ordering constraints. The Eiffel language's pre- and post-conditions (one of the few Object Oriented programming languages with this feature) allow these to be expressed at design time, and violations to be caught at run-time, but offers no means for discovering these constraints at run-time.

Human interaction. In object-oriented programming, a method is a process performed by an object when it receives a message. Methods are a programming shorthand that allows for efficient interaction within applications at run-time. But the cost of this efficiency is the draining of semantic cues necessary for human understanding. A typical user, such as a buyer in a market place, would not be able to understand the meaning of a method call picked at random from an application or to express certain intent within the application. This is the domain of the professional programmer, not a typical user.

Constraints. Object-oriented languages are very weak at expressing propositions or constraints—they were never designed for it. But these types of expressions are very important for people, as well as programs, attempting to interact with newly discovered E-services. “Do you sell any ice-cream with all-natural ingredients but less than 12% fat?” or “I will sell you orange Rockport loafers, size 15, for $59.95 plus $7.00 for tax and shipping” are natural marketplace expressions that are very difficult to express in the Object model without creating specialized sub-languages.

Infrastructure complexity. Distributed objects require complex infrastructures that are inaccessible to non-programmers. The lightweight and simplicity of HTML and HTTP is one of the reasons for the explosion of the Web (an estimated 800,000,000 pages as of February 1999 [5]); it is dubious that this would have been possible if the Web had been based on, for example, CORBA technology.

For these reasons, the Object model is a poor match to the requirements of the E-services domain.

The Agent Model:

The Agent model uses agent communication language (agent language or ACL) and includes various models such as collaborative, interface, mobile, information, reactive, and hybrid. The term “agent” is used herein to refer to the collaborative agent model, which is especially applicable to E-services for its model of agent roles and communication.

Agents are active rather than passive, and thus are capable of being responsible for achieving their own goals and avoiding deadlock, providing the robustness that the object model lacks. Agents communicate using an agent-independent language, side-stepping the design-time binding problem by allowing runtime determination of what other agents can “understand” by using ontologies as will later be described, while avoiding the overhead of introspection. The use of an agent-independent language also reduces much of the complexity of communication, as will later be described.

Referring now to Table 1, therein is shown a comparison of the Object model with the Agent model.

TABLE 1
The Object Model and the Agent Model

| | Object Model | Agent Model |
|---|---|---|
| Communication | interfaces | agent-independent language |
| Interaction | synchronous | asynchronous |
| Activity | passive | active |
| Autonomy | no (stimulus/response) | yes (goal-directed) |
| Robustness | design-time/run-time | self-responsible |
| | infrastructure | |

The most popular agent languages are based on the Speech Acts theory, a field arising both from philosophy and linguistics. The Speech Acts theory is described in more detail in “How To Do Things With Words,” by Austin, Second Edition, Edited by J. O. Urmson and Marina Sbis'a, Oxford, New York, Oxford University Press, 1962 [reprinted 1986] and “Speech Acts: Essays In The Philosophy Of Language,” by Searle, Cambridge University Press, 1969.

A Speech Act, also called a “performative”, is “the action performed by language to modify the state of the object on which the action is performed. It represents an action effectively fulfilled by a sentence.” A discussion regarding this aspect of the Speech Act can be found in Cicognani, Maher, “Design Speech Acts. ‘How to Do Things with Words’ in Virtual Communities,” Proceedings, Computer-Aided Architecture Design Futures, 1997.

In the context of agent communication, a performative may be thought of as consisting of four parts. The first part includes a verb conveying the general intent of the sentence. In agent languages, the verbs comprise such concepts as “propose,” “query,” “advertise,” “subscribe,” “agree” and so on.

The second part includes the specification of an ontology. An ontology is a vocabulary limited to a specific domain, containing words that are precisely defined. A “music” ontology, for example, might contain such words as “composer” or “performer”. On the other hand, a general business ontology might include “address,” “name,” “payment” and “credit-card”.

The third part includes an optional action word taken from the specified ontology. The action word, such as “buy” or “sell,” is cast as an infinitive and combined with the verb to refine the intent of the sentence. For example, the action word “buy” may be combined with the verbs “propose” or “agree” to form the perfornatives meaning “I propose to buy” or “I agree to buy”.

The fourth part includes a constraint expression relating selected entries from the ontology to values. For example, an expression about pieces of music composed by Beethoven and performed by Horowitz or Szell might be “(composer=Beethoven) && ((performer=Horowitz) ∥ (performer=Szell))”. The constraint expression is independent of the verb, so that a given constraint may be combined with different verbs to create sentences with very different meanings.

As an example, the statement “I would like to receive proposals for selling music composed by Beethoven that sells for less than $1.00” might be expressed (using an ad-hoc syntax) as a performative such as:

call-for-proposal ontology=music action=sell (composer=Beethoven) & (price<1.00)

The dominant agent communication languages (ACL) in use today is Knowledge Query Manipulation Language (KQML) proposed by Yannis Labrou and Tim Finin [A Proposal for a New KWML Specification: Yannis Labrou and Tim Finin, Feb. 3, 1997, Department of Computer Science and Electrical Engineering, University of Maryland, Baltimore County, Baltimore, Md. 21250, USA]. KQML was designed for collaborating agents working in a trusted environment. The Foundation for Intelligent Physical Agents (FIPA) has also developed its own competitive agent language (FIPA ACL) which is aimed to overcome some of the shortcomings of KQML.

An ontology may be considered as a vocabulary within a domain of discourse. Ontology is important because according to the Ontology organization of Farnborough, Hampshire, UK [site at http://www.ontology.org]:

“[a]n ontology provides a set of well-founded constructs that can be leveraged to build meaningful higher level knowledge. The terms in an ontology are selected with great care, ensuring that the most basic (abstract) foundational concepts and distinctions are defined and specified. The terms chosen from a complete set, whose relationship to one another is defined using formal techniques. It is these formally defined relationships that provide the semantic basis for the terminology chosen. An ontology is more than a taxonomy or classification of terms. Although taxonomy contributes to the semantics of a term in a vocabulary, ontologies include richer relationships that enable the expression of domain-specific knowledge, without the need to include domain-specific terms.”

The relationships between words within an ontology allows for the specification of structure. For example, in the CBL ontology supported by CommerceNet, the word “address.physical” is actually a compound term that includes the terms “street,” “city” and “country,” among others.

A considerable amount of work has been invested in developing ontologies for E-commerce by CommerceNet and Ontology.Org, which can be leveraged.

Agent languages answer the “what to say” problem of loosely-coupled systems, but this is insufficient. One must also specify the legal protocols, the “how you say it,” for communication between two entities using the language. Agent languages like KQML and FIPA ACL place restrictions on the exchange of performatives between agents to provide for higher-order communication. These multi-message exchanges, called conversations, allow for such activities as:

queries

requests

contract formation

auctions

subscriptions

etc. . . .

The agent paradigm has several advantages for use in the E-services world:

Robustness. Agents are active entities that are responsible for their own goals and for maintaining their own viability. They make few assumptions about the integrity of the other agents that it deals with. Received messages are viewed as requests, not commands, that may be analyzed and refused at the receiver's discretion. This model of activity and self-responsibility maps well onto the needs of an E-service.

Security. Agents communicate at the linguistic level, having no need to exchange code in order to achieve their objectives, thus circumventing one of the security risks of the Object model.

Semantics. Agents simplify the problem of semantics in several ways. First, agent ontologies provide a systematic and disciplined means of establishing meanings for terms that can be easily shared and understood by E-services and E-clients.

Second, agents use semantic factoring of actions. An action is the combination of a verb, whose meaning is fixed by the language, and an optional action word taken from a specified ontology. Since verbs and action words may be combined independently, the number of expressible actions is equal to the product of the number of verbs (“V”) in the language times the number of action words (“A”) in the ontology. Thus V×A actions can be expressed through the definitions of only V+A terms. With multiple ontologies containing A₀, A₁, A₂, . . . action words, a total of ((V×A₀)+(V×A₁)+(V×A₂)+ . . . ) actions can be expressed with only (V+A₀+A₁+A₂+ . . . ) definitions—a significant reduction in complexity.

Finally, terms can be added to an ontology without breaking or requiring the recompilation of older agents. More importantly, their structured nature allows for the possibility of plug-and-play ontology modules that could be used to update running E-services.

Interaction Protocols. ACL define legal message exchange sequences that can be determined at run-time.

Human Interaction and Constraints. The agent linguistic communication model is much closer to the expressiveness of human language than the other two paradigms, namely the Document model and the Object model, and therefore simplifying interactions with people.

While the ACL are theoretically good for generalized communication, they are not suitable for use on the Web for two reasons:

First, they are unfamiliar to the vast majority of businesses and developers on the Web today

Second, They require specialized software “engines” for interpretation that are rarely used in business today, and are unproven with respect to robustness (such as resistance to attack through hostile queries, reliability, and so on).

There is a need therefore, for an improved communication language and model that overcomes the aforementioned shortcomings of the existing ACL and provides an attractive communication infrastructure for E-services that leverages existing Web technologies.

### DISCLOSURE OF THE INVENTION

The present invention provides an improved communication language and model that overcomes the shortcomings of the existing agent communication languages (ACL) and provides an attractive communication infrastructure for E-services that leverages existing Web technologies.

The present invention enables rapid E-service development, and immediate usability by browser-based clients, including both human user and machine user.

The present invention further provides a network communication method and system which uses existing or new ACL with Structured Query Language (SQL) as the constraint language and eXtensible Markup Language (XML) for syntax. SQL is a database sub-language used in querying, updating, and managing relational databases. Since SQL is by far the dominant language used by relational databases today, the use of SQL allows a Web developer to use existing databases for processing the constraint part of a message with little or no modifications

The present invention further provides a communications network, which includes a server software module adapted to communicate with a machine user; an ACL interpreter adapted to communicate with the server software module; and a file system adapted to communicate with the ACL interpreter. The machine user sends requests to the server software module using an ACL with SQL as a constraint language.

The present invention also provides a method of information transfer for a communications network which includes: (1) sending a first request from a machine user to a server software module using an ACL with SQL as a constraint language; (2) sending a second request from the server software module to an ACL interpreter in response to the first request; and (3) sending a third request from the ACL interpreter to a file system in response to the second request.

The above and additional advantages of the present invention will become apparent to those skilled in the art from a reading of the following detailed description when taken in conjunction with the accompanying drawings.

### BRIEF DESCRIPTION OF THE DRAWINGS

FIG. 1 (PRIOR ART) is a schematic of a prior art Web site using HTML/HTTP to communicate with a human user; and

FIG. 2 is a schematic of a Web site augmented with an ACL-based E-service communication infrastructure constructed in accordance with the present invention.

### BEST MODE FOR CARRYING OUT THE INVENTION

The present invention allows the powerful ACL paradigm to be used for automated E-services over the Web without disturbing existing E-business infrastructures, and leverages the pre-existing large investment in database technology. The present invention uses extensible Markup Language (XML) exclusively for communication and therefore will leverage such efforts as those of CommerceNet and Ontology.org (both of which use XML to define ontologies) and the growing support for XML technology. Another advantage is that communications with the underlying infrastructure, for doing such things as establishing initial connection or secure transport, are independent of this system.

The present invention enables rapid E-service development, and immediate usability by browser-based clients. Without these abilities, it is difficult to bootstrap E-services. Since short time-to-market is a critical success criteria in E-services, there is little incentive to create a programmatic interface for an E-service if the potential service provider must wait months for client programs to be developed that use that interface. The present invention sidesteps this problem by providing immediate human and machine usability with all of the facilities needed for programmatic interaction.

As used throughout this application, the term “machine user” denotes a Web site client, which is not human and includes a computer system such as a mainframe computer, a workstation, a server, a personal computer, and a combination thereof. The machine user is capable of requesting and receiving services from a Web site without human intervention. On the other hand, the term “human user” as used throughout this application denotes a Web site client who is a human being and who is requesting and receiving services from a Web site through the use of a computer system or other similar systems.

In accordance with the present invention, components are supplied to allow the creation of an E-service from an existing (or new) application with a minimum of software coding. On the client or user side, the present invention enables browser plug-ins and allows immediate client usability. This plug-in would help users query, negotiate and form contracts for E-services in a uniform way, and assist in understanding the service's semantics and also in translating between different human languages (with the help of ontology plug-ins).

The present invention uses the Agent paradigm recast into the Document environment to provide an easy growth path for Web sites and Web developers to extend from the HTML world to the XML world to the E-services world. The present invention supplements the extended Document paradigm (such as XML Schema and RDF Schema, and XML ontologies) where it falls short—in actions and protocols—by incorporating it with the strength of the Agent paradigm. Since the target audience for E-services consists mainly of Web developers, and not distributed application developers (who are used to the DCOM, CORBA, EJB models), the present invention provides a new approach to E-services on the Web.

The present invention provide a method and system that can be added on to an existing E-service infrastructure to create an E-service without disturbing the existing investment in server and database technology.

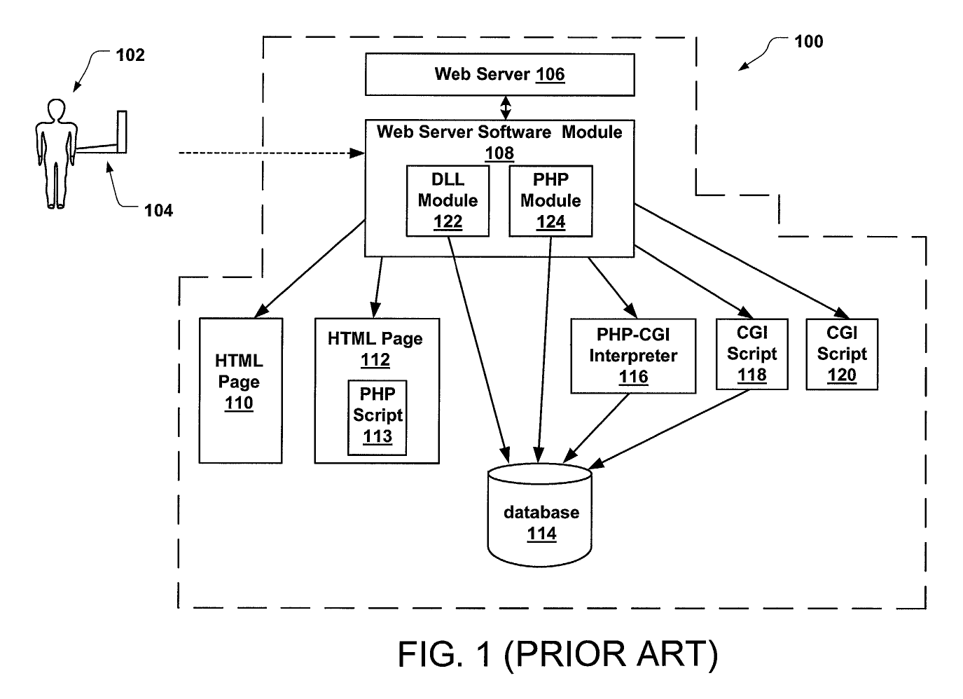

Referring now to FIG. 1 (PRIOR ART), therein is shown a conventional Web site 100, which uses HTML/HTTP to communicate with a human user 102 via a computer system 104. The Web site 100 includes a Web server 106. The Web server 106 is a HTTP server and includes one or a plurality of personal computers, workstations, or mainframe computers (not shown) operating in accordance with one or a number of known operating systems, e.g., UNIX, Windows 95/98/NT. The Web site 100 also includes a Web server software module 108, a first HTML page 110, a second HTML page 112, a database 114, a PHP-CGI Interpreter 116, a first common gateway interface (CGI) script 118, and a second CGI script 120. PHP, which stands for “PHP: Hypertext Preprocessor”, is an HTML-embedded scripting language. The Web server 106 is coupled to the Web server software module 108.

The Web server software module 108 has a dynamic-link library (DLL) module 122 and a PHP module 124. DLL is a feature of the Microsoft Windows of family of operating system that allows executable routines to be stored separately as files with DLL extensions and to be loaded only when needed by a program.

The second HTML page 112 includes a PHP script 113. Scripts are applications that are executed by a HTTP server in response to a request by a client user.

The database 114 includes a collection of data in a memory system. The data is organized so that it can be searched, indexed, sorted, updated, etc..

Generally, a CGI script is invoked when a user clicks on an element in a Web page, such as a link or image. CGI scripts are used to provide interactivity in a Web page. Communication between the CGI script and the server is governed by the CGI specification. CGI scripts can be written in many languages including C, C++, and Practical Extraction and Report Language (Perl).

The PHP-CGI Interpreter 116 is an application program that translates instructions in PHP format into CGI format.

In operation, the human user 102 sends a request to the Web site 100 using the computer system 104. The request is in HTML format and is communicated to the Web site 100 via HTTP. In response, the Web server software module 108 may do one or more of the following: (1) provides to the human user a first HTML page 110; (2) provides to the human user 102 the second HTML page 112 using PHP script 113; (3) provides to the human user 102 data information from database 114 by accessing the database 114 via the DLL module 122; (4) provides to the human user 102 data information from database 114 by accessing the database 114 via the PHP module 124; (5) provides to the human user 102 data information from the database 114 by accessing the database 114 via the PHP-CGI Interpreter 116; (6) provides to the human user 102 data information from database 114 by accessing the database 114 via the DLL module 122; (7) provides to the human user 102 data information from database 114 by accessing the database 114 via the first CGI script 118; and (8) provide to the human user 102 information by using the second CGI script 120.

Most users for the Web site 100 are people because of the lack of semantics in HTML. While it is possible to programmatically “scrub” desired information from a Web page by studying the conventions used by that particular page, there is no systematic way that a program used by a machine user can understand the contents of any given page. This is a tremendous impediment to the development of an automated E-service infrastructure, which requires easy and direct communication between machine users and Web sites.

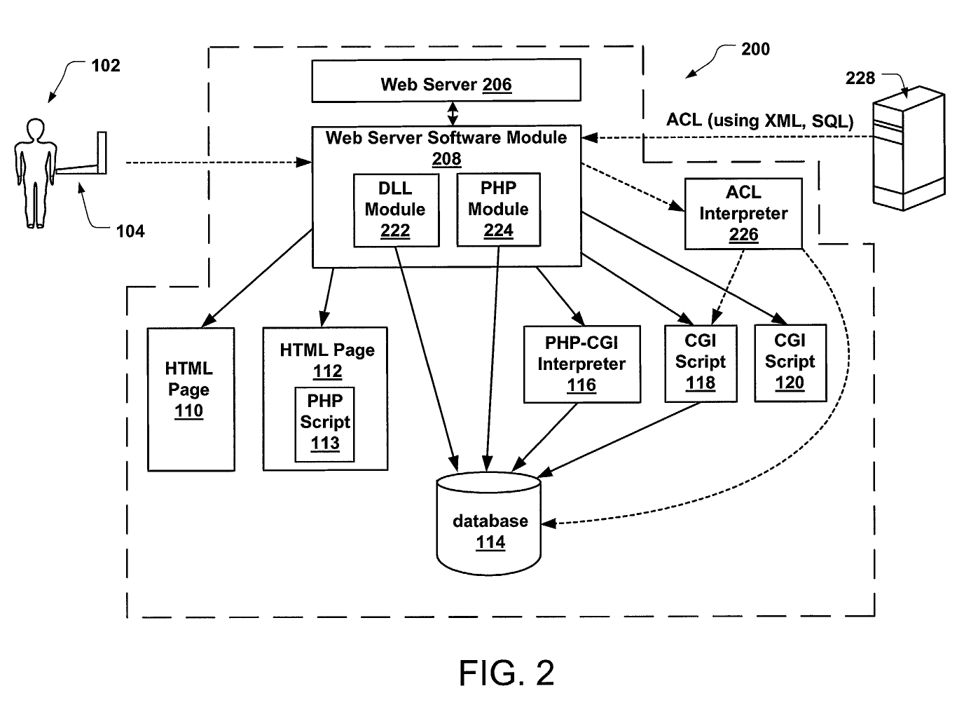

Referring now to FIG. 2, therein is shown a Web site 200 constructed in accordance with the present invention. Like reference numerals are used in FIG. 2 to denote like elements already described in FIG. 1 (PRIOR ART).

The Web site 200 includes a Web server 206. The Web server 206 is a HTTP server and may include one or a plurality of personal computers, workstations, or mainframe computers operating in accordance with one or a number of known operating systems, e.g., UNIX, Windows 95/98/NT. The Web site 200 is augmented with an agent communication language (ACL) based E-service communication infrastructure. The Web site 200 includes a Web server software module 208, the first HTML page 110, the second HTML page 112, the database 114, the PHP-CGI Interpreter 116, the first common gateway interface (CGI) script 118, the second CGI script 120, and an ACL interpreter 226.

The Web server software module 208 has the DLL module 122 and the PHP module 124. The second HTML page 112 includes the PHP script 113. The database 114 includes a collection of data stored in a memory system.

The PHP-CGI Interpreter 116 is an application program that translates instructions in PHP format into CGI format.

The ACL interpreter 226 interprets and translates requests from the Web server software module 208 so that they are readable by the first CGI script 118. The first CGI script 118 then communicates with database 114 similar to what was described in FIG. 1 (PRIOR ART). Alternatively, the ACL interpreter 226 may communicate directly with the database 114 for resolving queries, fulfilling orders, etc., without the need for additional constraint engine software, which require modifications to the database.

In operation, a machine user 228 sends a request to the Web site 200. The request is in ACL using SQL as the constraint language and XML for syntax. In response, the Web server software module 208 forwards the request to the ACL interpreter 226. The ACL interpreter 226 translates the request so that it is readable by the first CGI script 118. The first CGI script 118 then communicates with the database 114 for retrieving data information according to the request by the machine user 228. Alternatively, the ACL interpreter 226 translates the request and communicates directly with the database 114 for resolving queries, fulfilling orders, etc., as requested by the machine user, without the need for additional constraint engine software. Since SQL is the dominant language used by most relational database today, the use of SQL as the ACL constraint language in accordance with the present invention allows the use of existing databases for processing the constraint part of a request.

The servicing of requests from human users is unaffected and is similar to what was described in FIG. 1 (PRIOR ART). At the same time, the present invention allows machine users to interact with the Web sites in a meaningful way.

Accordingly, the present invention provides a Web site augmented with an ACL-based E-service communication. The use of ACL with SQL as the constraint language and XML for syntax provides an easy growth path for Web sites and Web developers to extend from the HTML world to the XML world to the E-services world. Advantageously, by using SQL as the ACL constraint language, the existing database can be used for resolving queries, fulfilling orders, etc., without the need for additional constraint engine software. As a result, the existing database can be used with little or no modification. Therefore, the present invention can easily be added on to an existing E-business to create an E-service without disturbing the existing investment in server and database technology.

While the best mode involves sending requests to a database, it should be understood that requests may be sent to other devices for information retrieval or display. Since databases are the core of the e-service application, any application requiring a database would be supported by the present invention.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations which fall within the spirit and scope of the included claims. All matters hither-to-fore set forth herein or shown in the accompanying drawings are to be interpreted in an illustrative and non-limiting sense.

The invention claimed is:

1. A communications network, comprising:
a server software module adapted to communicate with a machine user;
an agent communication language (ACL) interpreter adapted to communicate with the server software module;
a file system adapted to communicate with the ACL interpreter, wherein the machine user sends requests to the server software module using an ACL with Status Query Language (SQL) as a constraint language.

2. The communications network as claimed in claim 1 wherein the server software module is a Web server software module.

3. The communication network as claimed in claim 1 wherein the server software module is adapted to communicate with a human user.

4. The communication network as claimed in claim 1 wherein the server software module includes:
a Direct Link Library module adapted to communicate with the file system; and
a PHP module adapted to communicate with the file system.

5. The communications network as claimed in claim 1 wherein the machine user comprises a computer system selected from the group consisting of a mainframe computer, a workstation, a server, and a personal computer.

6. The communications network as claimed in claim 1 wherein the machine user sends requests to the server software module using the ACL with eXtensible Markup Language (XML) for syntax.

7. The communications network as claimed in claim 1 wherein the ACL comprises Knowledge Query and Manipulation Language (KQML).

8. The communications network as claimed in claim 1 wherein the ACL comprises a Foundation for Intelligent Physical Agents (FIPA) agent communication language.

9. The communications network as claimed in claim 1 wherein the file system is a database system.

10. The communications network as claimed in claim 1 further including a Common Gateway Interface (CGI) script adapted to communicate with the file system..

11. The communications network as claimed in claim 10 wherein the ACL interpreter is adapted to communicate with the file system via the CGI script.

12. A Web site comprising:
a Web server software module adapted to communicate with a machine user, wherein the machine user includes a computer system selected from the group consisting of a mainframe computer, a workstation, a server, and a personal computer, the Web server software module including a Direct Link Library module and a PHP module;
an agent communication language (ACL) interpreter adapted to communicate with the Web server software module;
a database system adapted to communicate with the ACL interpreter, wherein the machine user sends requests to the server software module using an ACL with Status Query Language (SQL) as a constraint language and extensible Markup Language (XML) for syntax; and
a Common Gateway Interface (CGI) script adapted to communicate with the database system and the ACL interpreter.

13. A method of information transfer for a communications network, comprising:
sending a first request from a machine user to a server software module using an agent communication language (ACL) with Status Query Language (SQL) as a constraint language;
sending a second request from the server software module to an ACL interpreter in response to the first request; and
sending a third request from the ACL interpreter to a file system in response to the second request.

14. The method as claimed in claim 13 wherein the sending of the first request to the server software module uses a server software module including:
a Direct Link Library module adapted to communicate with the file system; and
a PHP module adapted to communicate with the file system.

15. The method as claimed in claim 13 wherein the sending of the first request to the server software module sends the first request to a Web server software module.

16. The method as claimed in claim 13 further including:
sending a request from a human user to the server software module using Hypertext Transfer Protocol (HTTP).

17. The method as claimed in claim 13 wherein the machine user includes a computer system selected from the group consisting of a mainframe computer, a workstation, a server, and a personal computer.

18. The method as claimed in claim 13 wherein the sending of the first request from the machine user to the server software module uses the ACL with eXtensible Markup Language (XML) for syntax.

19. The method as claimed in claim 13 wherein the sending of the first request from the machine user to the server software module using an agent communication language (ACL) uses Knowledge Query and Manipulation Language (KQML).

20. The method as claimed in claim 13 wherein the sending of the first request from the machine user to the server software module using an agent communication language (ACL) uses a Foundation for Intelligent Physical Agents (FIPA) agent communication language.

21. The method as claimed in claim 13 wherein the sending of the third request from the ACL interpreter to a file system sends the third request to a database system.

22. The method as claimed in claim 13 further including sending a fourth request from the ACL interpreter to a Common Gateway Interface (CGI) script in response to the second request.

23. The method as claimed in claim 22 further including sending a fifth request from the CGI script to the file system.

24. A method of information transfer for a Web site, comprising:
sending a first request from a machine user to a Web server software module using an agent communication language (ACL) with Status Query Language (SQL) as a constraint language and extensible Markup Language (XML) for syntax, wherein the machine user comprises a computer system selected from the group consisting of a mainframe computer, a workstation, a server, and a personal computer, the Web server software module including a Direct Link Library (DLL) module and a PHP module;
sending a second request from the server software module to an ACL interpreter in response to the first request;
sending a third request from the ACL interpreter to a database system in response to the second request;
sending a fourth request from the ACL interpreter to a Common Gateway Interface (CGI) script in response to the second request; and
sending a fifth request from the CGI script to the database system
